(19) United States
(12) Patent Application Publication
(10) Pub. No.: US 2019/0236509 A1
(43) Pub. Date: Aug. 1, 2019

(54) ENGAGEMENT SYSTEM

(71) Applicant: LINK AND MOTIVATION INC., Tokyo (JP)

(72) Inventors: Yoshihisa OZASA, Tokyo (JP); Hideki SAKASHITA, Tokyo (JP)

(73) Assignee: Link and Motivation Inc., Tokyo (JP)

(21) Appl. No.: 16/320,371

(22) PCT Filed: Jul. 25, 2017
(86) PCT No.: PCT/JP2017/026918

§ 371 Date: Jan. 24, 2019

(30) Foreign Application Priority Data
Jul. 25, 2016 (JP) 2016-145578

(51) Int. Cl. G06Q 10/06; G06F 16/22

(52) U.S. Cl. CPC G06Q 10/06393; G06F 16/22

(57) ABSTRACT

An engagement system for assisting reinforcement and improvement of an organization according to the present invention includes: a survey response compiling part that generates a survey compilation result by compiling responses to multiple survey questions; an improvement item proposing part that proposes at least one action plan according to the survey compilation result; an action plan setting part that accepts selection of the action plan, and sets the action plan as an action plan that is to be implemented; and an action plan progress managing part that accepts registration of a progress status regarding the action plan that is to be implemented.

### TECHNICAL FIELD

The present invention relates to an engagement system, and particularly relates to an engagement system for assisting work sites and human-resources departments in reinforcing and developing their organizations.

### BACKGROUND ART

Conventionally, systems are proposed that implement a questionnaire survey for members of an organization, analyze results of the questionnaire survey, and make it possible to see the actual status of the business of the organization including business content of the organization, consciousness of the members, and the like, thereby assisting administrators of the organization in improving the business.

For example, Patent Document 1 discloses a system that implements a questionnaire with multiple questionnaire items for members of a group, analyzes results of the questionnaire to calculate scores regarding consciousness of the members, and analyzes a status of each member and a status of the entire group based on the calculated scores. With the system disclosed in Patent Document 1, it is possible to see an actual status of business of an organization, and to investigate an optimal method for improving the current actual status of the business.

### CITATION LIST

### Patent Document

Patent Document 1: Japanese Patent No. 5854988

### SUMMARY OF INVENTION

### Technical Problem

With a recent increase in the ratio of the tertiary sector of industry (service sector) in the entire industry, it is becoming more important to obtain excellent human resources than to obtain facilities or funds, in order to produce products. Furthermore, due to high speed of a change in the environment and high speed of obsolescence of products, it is necessary to build an organization that can produce hit products one after another in short spans.

Meanwhile, with a recent development of the infrastructure for job change, it is becoming more common to change jobs. Thus, for each organization, the retention for preventing once attained human resources from leaving the organization is important. Furthermore, members constituting an organization have various senses of values, and work engagement that is work motivation of the members changes in various manners as well. Accordingly, for each organization, it is necessary to build an organization that can maintain work engagement of various members.

The attempt to build such an organization has to be continuously made in order to continuously deal with the above-described situations.

However, the system disclosed in Patent Document 1 does not have a configuration for continuously reinforcing and improving an organization, and thus this system is not suitable to continuously build an organization that conforms to a change in the environment and the like as described above.

Furthermore, according to the system disclosed in Patent Document 1, the degree of association of each member constituting an organization with another member, and his or her consciousness for disciplinary rules in the company are expressed as scores and plotted, and the entire status of the company is analyzed based on the plotted results. That is to say, with the analysis method disclosed in Patent Document 1, it is not possible to perform an analysis from the viewpoint of senses of values of respective members constituting the organization although the entire status of the company can be seen. Thus, this technique is problematic in that it is not possible to sufficiently analyze from which viewpoint in reinforcing and improving an organization is most effective to maintain work engagement of members of the organization.

It is an object of the present invention to provide an engagement system that enables work sites and human-resources departments to reinforce and develop their organizations.

### Solution to Problem

An aspect according to claim 1 of the present invention is directed to an engagement system for assisting reinforcement and improvement of an organization, including: a survey response compiling part that generates a survey compilation result by compiling responses to multiple survey questions; an improvement item proposing part that proposes at least one action plan according to the survey compilation result; an action plan setting part that accepts selection of the action plan, and sets the action plan as an action plan that is to be implemented; and an action plan progress managing part that accepts registration of a progress status regarding the action plan that is to be implemented.

An aspect according to claim 2 of the present invention is directed to the engagement system according to claim 1, further including: a database in which a survey compilation result of a previously implemented survey is stored; and a time-series comparison displaying part that displays the survey compilation result compiled by the survey response compiling part and a survey compilation result of a previously implemented survey stored in the database, in comparison with each other, referring to the database.

An aspect according to claim 3 of the present invention is directed to the engagement system according to claim 1 or 2, further including: a database in which a survey analysis results of a survey implemented in multiple organizations is stored; and an inter-organization comparison displaying part that displays the survey compilation result compiled by the survey response compiling part and a survey compilation result of a survey implemented in multiple organizations and stored in the database, in comparison with each other, referring to the database.

An aspect according to claim 4 of the present invention is directed to the engagement system according to any one of claims 1 to 3, further including an intra-organization analysis displaying part that calculates a survey analysis result by analyzing the survey compilation result, and provides the calculated survey analysis result, wherein the survey analysis result includes a graph regarding an expectation level and a satisfaction level for items related to multiple diagnosis regions calculated by the survey response compiling part, in which the items related to the multiple diagnosis regions are plotted on a first axis indicating the expectation level and a second axis indicating the satisfaction level.

### Advantageous Effects of Invention

According to the system of the present invention, it is possible to express a status of an organization by visualizing and quantifying, from various viewpoints, work engagement that is work motivation of members of the organization, and thus it is possible to find which way to reinforce and improve the organization is most effective to maintain work engagement of members of the organization. Furthermore, according to the system of the present invention, not only seeing the current status but also continuously performing goal setting and progress management is assisted, and thus it is easy for members at work sites and human-resources departments to continuously reinforce their organizations.

### BRIEF DESCRIPTION OF DRAWINGS

FIG. 1 is a diagram showing the overall configuration of an engagement system according to an embodiment of the present invention.

FIG. 2 is a functional block diagram of a survey server according to an embodiment of the present invention.

FIG. 3 is a functional block diagram of a management server according to an embodiment of the present invention.

FIG. 4 is a diagram showing an example of a page showing responses to survey questions and an example of survey questions that are used by the engagement system according to an embodiment of the present invention.

FIG. 5 is a diagram showing an example of items related to diagnosis regions that are used by the engagement system according to an embodiment of the present invention.

FIG. 6 is a display example in which a survey result is organized from the viewpoint of work engagement to an organization or a supervisor, in the engagement system according to an embodiment of the present invention.

FIG. 7 is a display example in which a survey result is organized such that items in diagnosis regions are plotted on two axes indicating expectation and satisfaction levels, in the engagement system according to an embodiment of the present invention.

FIG. 8 is a display example in which a survey result is organized from the viewpoint of department, position, sex, year joined the company, and the like, in the engagement system according to an embodiment of the present invention.

FIG. 9 is an example in which a survey analysis result is displayed in comparison with previously accumulated analysis results, in the engagement system according to an embodiment of the present invention.

FIG. 10 is a table showing an example of action plans that are used in the engagement system according to an embodiment of the present invention.

FIG. 11 is a table showing an example of a progress status display of action plans that are to be implemented.

### DESCRIPTION OF EMBODIMENT

Hereinafter, an embodiment of the present invention will be described with reference to the drawings.

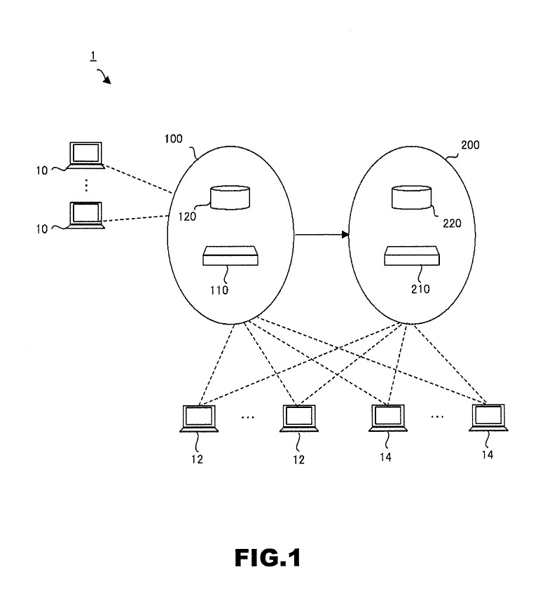

FIG. 1 shows the overall configuration of an engagement system according to an embodiment of the present invention. An engagement system 1 of this embodiment has a configuration in which multiple respondent terminal apparatuses 10, multiple administrator terminal apparatuses 12, multiple work-site manager terminal apparatuses 14, at least one survey server 100, and a management server 200 are connected to each other via a communication line such as the Internet.

The respondent terminal apparatuses 10 are terminals that are used by members of an organization that is to be managed by the engagement system 1 of this embodiment, and are used by the members of the organization to input responses to a survey (questionnaire).

The administrator terminal apparatuses 12 are terminals that are used by administrators (corporate managers, human-resources staff, etc.) of an organization that is to be managed by the engagement system 1 of this embodiment, and are used to access the later-described survey server 100 and register implementation of a survey for members, and to access the later-described management server 200, and analyze a survey and view analysis results, provide a comparison with analysis results of previously implemented surveys or analysis results of surveys implemented in other organizations, and perform tasks such as viewing, setting, progress management, and the like of action plans.

The work-site manager terminal apparatuses 14 are terminals that are used by work-site managers (those who manage departments in an organization, such as managers of departments or sections) of an organization that is to be managed by the engagement system 1 of this embodiment, and are used to access the later-described management server 200 and perform tasks such as viewing, setting, progress management, and the like of action plans.

Note that it is also possible that the administrator terminal apparatuses 12 and the work-site manager terminal apparatuses 14 function as terminal apparatuses for surveys for administrators and work-site managers (as in the case of the respondent terminal apparatuses 10).

The survey server 100 is a server that provides survey questions to the respondent terminal apparatuses 10, and accepts responses to the survey questions from the respondent terminal apparatuses 10. The survey server 100 includes an interface server 110 that functions as an interface for providing survey questions and accepting responses to the survey questions, and a database 120 in which survey questions and responses to the survey questions from members of organizations, information for identifying members, administrators, and work-site managers of organizations, information for identifying departments of members, administrators, and work-site managers of organizations, information for identifying organizations, information indicating attributes such as positions of members, administrators, and work-site managers of organizations, information for identifying terminals that are used by organizations, and the like can be stored.

In response to registration of implementation of a survey by an administrator terminal apparatus 12, the survey server 100 provides survey questions stored in the database 120 to the respondent terminal apparatuses 10 via the interface server 110, and accepts responses to the provided survey questions from the respondent terminal apparatuses 10. The survey server 100 compiles members' responses to the survey questions stored in the database 120 included in the survey server 100, and transfers the compilation result to a database 220 included in the later-described management server 200. The interface server 110 included in the survey server 100 may be configured as a mail server, for example, and, in this case, the interface server 110 exchanges data with the above-described terminal apparatuses by e-mail. Alternatively, the interface server 110 may be configured as a WEB server, for example, and, in this case, the interface server 110 exchanges data with the above-described terminal apparatuses by HTTP.

The survey server 100 has a function of authenticating members of organizations, and can manage, for each member of organizations, responses to survey questions using the authenticating function. Furthermore, the survey server 100 has a function of authenticating administrators of organizations, and also has a function of approving the range of an organization that can be managed by administrators of the organization authenticated through the authenticating function. The survey server 100 may be prepared for each organization that is to be managed, or one survey server 100 may be prepared for multiple organizations. The survey server 100 may be installed inside an organization that is to be managed, or may be installed in an ASP or a cloud that is managed by a service company providing the engagement system 1.

The management server 200 is a server having a function of receiving and further analyzing a compilation result of organization members' responses to survey questions transferred from the survey server 100, and a function of assisting management of the organization based on the analysis result. The management server 200 includes an interface server 210 that functions as an interface for analyzing a survey and viewing analysis results, providing a comparison with analysis results of previously implemented surveys or analysis results of surveys implemented in other organizations, and performing tasks such as viewing, setting, progress management, and the like of action plans, and a database 220 in which responses to survey questions from members of organizations and an analysis result of the responses to the survey questions, action plans and implementation statuses of the action plans, information for identifying members, administrators, and work-site managers of organizations, information for identifying departments of members, administrators, and work-site managers of organizations, information for identifying organizations, information indicating attributes such as positions of members, administrators, and work-site managers of organizations, information for identifying terminals that are used by organizations, and the like can be stored for each organization.

In response to an instruction from an administrator terminal apparatus 12 to analyze a compilation result of organization members' responses to survey questions, the management server 200 analyzes the compilation result of the organization members' responses to the survey questions transferred from the survey server 100 and stored in the database 220, provides the analysis result to the administrator terminal apparatus 12, and stores the analysis result in the database 220. In response to a request from an administrator terminal apparatus 12, the management server 200 provides a comparison with compilation results of surveys previously implemented in the same organization or provides a comparison with compilation results of surveys implemented in other organizations, as an analysis result. In response to a request from an administrator terminal apparatus 12, the management server 200 proposes action plans according to a compilation result of organization members' responses to survey questions, sets an action plan selected by the organization from among the proposed action plans, and manages progress of the set action plan. The interface server 210 included in the management server 200 may be configured as a mail server, for example, and, in this case, the interface server 210 exchanges data with the above-described terminals by e-mail. Alternatively, the interface server 210 included in the management server 200 may be configured as a WEB server, for example, and, in this case, the interface server 210 exchanges data with the above-described terminals by HTTP.

The management server 200 has a function of authenticating administrators of organizations, and also has a function of approving the range of an organization that can be managed by administrators of the organization authenticated through the authenticating function. The management server 200 has a function of authenticating work-site managers of organizations, and also has a function of approving the range of an organization that can be managed by work-site managers of the organization authenticated through the authenticating function. The management server 200 can manage multiple organizations, and is installed in an ASP or a cloud that is managed by a service company providing the engagement system 1.

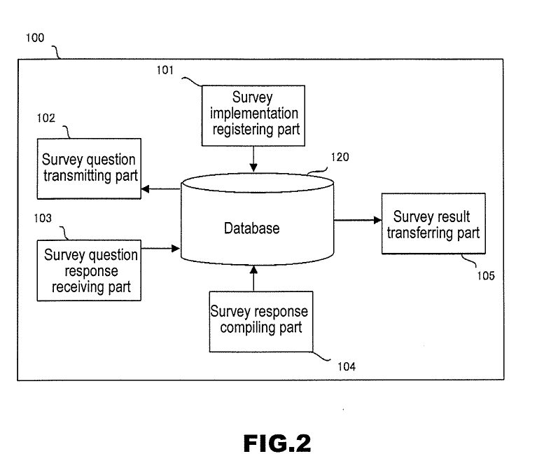

FIG. 2 is a functional block diagram of the survey server 100 of this embodiment. The survey server 100 of this embodiment includes a survey implementation registering part 101, a survey question transmitting part, a survey question response receiving part 103, a survey response compiling part 104, and a survey result transferring part 105.

In response to a request from an administrator terminal apparatus 12, the survey implementation registering part 101 registers implementation of a survey for members. The survey implementation registering part 101 registers information regarding a range or a period in which a survey is to be implemented and the like contained in the request from the administrator terminal apparatus 12, as survey implementation registration information, in the database 120.

Referring to survey implementation registration information stored in the database 120, the survey question transmitting part 102 transmits survey questions read from the database 120, to the respondent terminal apparatuses 10 in the survey implementation range registered in the survey implementation registration information, when it is the period registered in the survey implementation registration information. The survey question response receiving part 103 receives responses to the survey questions transmitted by the survey question transmitting part 102, from the respondent terminal apparatuses 10, and stores the received responses in the survey questions in the database 120. The responses to the survey questions received by the survey question response receiving part 103 are stored in the database 120 in association at least with information for identifying organization members who submitted the responses.

The survey response compiling part 104 performs compilation processing on the responses to the survey questions stored in the database 120, and stores the compilation result in the database 120. The method in which the survey response compiling part 104 performs compilation processing will be described later.

The survey result transferring part 105 transfers the compilation result of the responses to the survey questions stored in the database 120, as a survey result, to the management server 200. The result of the survey implementation that is transferred by the survey result transferring part 105 to the management server 200 is transferred to the management server 200 such that the responses to the survey questions are respectively in association at least with information for identifying organizations to which organization members who submitted the responses belong and information for identifying organizations that submitted the responses.

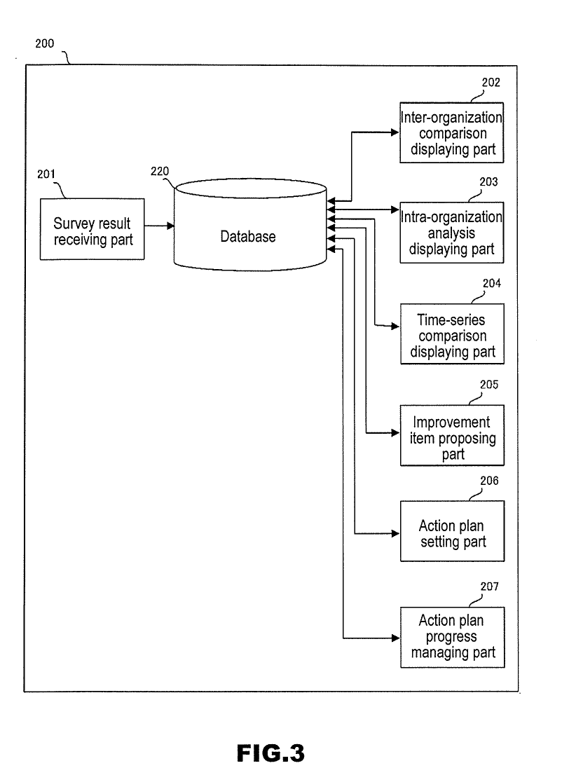

FIG. 3 is a functional block diagram the management server 200 of this embodiment. The management server 200 of this embodiment includes a survey result receiving part 201, an inter-organization comparison displaying part 202, an intra-organization comparison displaying part 203, a time-series comparison displaying part 204, an improvement item proposing part 205, an action plan setting part 206, and an action plan progress managing part 207.

The survey result receiving part 201 receives the survey result transferred from the survey server 100, and stores the survey result in the database 220. The survey result received by the survey result receiving part 201 is stored in the database 220 in association at least with information for identifying organizations in which the survey was implemented.

In response to a request from an administrator terminal apparatus 12, the inter-organization comparison displaying part 202 performs an analysis by comparing the compilation result of the responses to the survey questions stored in the database 220 and a compilation result of responses to the survey questions in other organizations, generates information as an analysis result, and provides the information to the administrator terminal apparatus 12. The analysis result may be stored in the database 220 as appropriate.

In response to a request from an administrator terminal apparatus 12, the intra-organization analysis displaying part 203 analyzes the compilation result of the responses to the survey questions in the organization stored in the database 220, generates information as an analysis result, and provides the information to the administrator terminal apparatus 12. Examples of the content of the analysis that is performed by the intra-organization analysis displaying part 203 include an distribution analysis, a comparison analysis in terms of department, sex, age, or the like, of items related to later-described diagnosis regions. The analysis result may be stored in the database 220 as appropriate.

In response to a request from an administrator terminal apparatus 12, the time-series comparison displaying part 204 performs an analysis by comparing the compilation result of the responses to the survey questions stored in the database 220 and a compilation result of responses to the survey questions previously obtained in the same organization, generates information as an analysis result, and provides the information to the administrator terminal apparatus 12. The analysis result may be stored in the database 220 as appropriate.

In response to a request from an administrator terminal apparatus 12, the improvement item proposing part 205 extracts at least one proper improvement item for the current organization status from the database 220 based on the compilation result and the analysis result of the responses to the survey questions, and provides the extracted improvement item to the administrator terminal apparatus 12.

The action plan setting part 206 sets an action plan for organization development in the organization or in a department in the organization according to an improvement item selected from among the at least one improvement item provided by the improvement item proposing part 205 to the administrator terminal apparatus 12, and stores the action plan in the database 220.

The action plan progress managing part 207 manages the progress status of the action plan for organization development in the organization or in the department in the organization set by the action plan setting part 206, through data exchanges with the administrator terminal apparatuses 12 and the work-site manager terminal apparatuses 14.

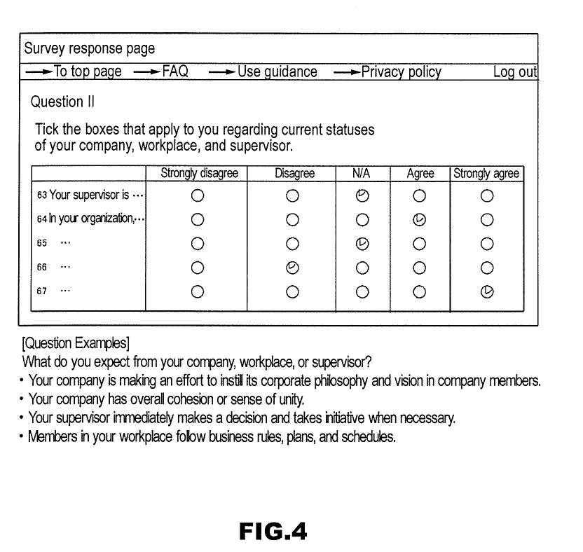

Hereinafter, a survey a survey analysis that are implemented in the engagement system 1 of this embodiment and will be described with respect to FIGS. 4 to 10.

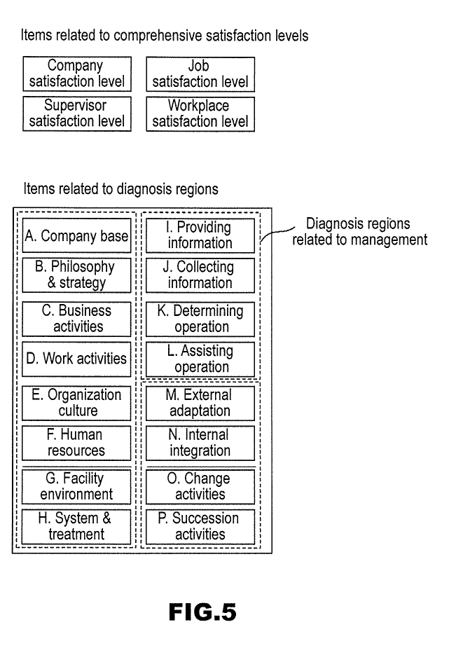

FIG. 4 is a diagram showing an example of a page showing responses to survey questions and an example of survey questions that are used in a survey that is implemented in the engagement system 1 of this embodiment. In a survey that is implemented in the engagement system 1 of this embodiment, multiple survey questions for measuring work engagement including work motivation for an organization or a supervisor and the like are provided to members of the organization, and responses to the survey questions are accepted. The survey questions that are provided to members of the organization are questions for measuring the level at which organization members are satisfied with their organization, work, supervisors, and workplace, and the levels at which the members have expectations for items related to multiple diagnosis regions (what he or she expects from the company) and are satisfied with the items (what he or she is satisfied with in the company), as given as an example in FIG. 5. In the engagement system 1 of this embodiment, the items related to diagnosis regions may be divided into groups indicating features of the diagnosis regions (item groups of diagnosis regions related to management, etc.). For each survey question, for example, scores related to the level at which organization members are satisfied with their organization, work, supervisors, and workplace, and scores related to expectation and satisfaction levels in the respective diagnosis regions are defined according to the organization member' responses to the survey question, and the survey response compiling part 104 included in the engagement system 1 of this embodiment compiles (e.g., averages, etc.), for each organization, for each organization department, for each member attribute, or the like, the scores regarding the level at which organization members are satisfied with their organization, work, supervisors, and workplace, and expectation and satisfaction levels for the items related to the diagnosis regions, based on responses to the survey question from the member of the organization or the member belonging to the department of the organization. The survey response compiling part 104 may further obtain an average of compilation results for each item, for each of the groups indicating features of the diagnosis regions. It is possible that the scores are defined with respect to combinations of responses to multiple survey questions, and it is also possible that not only the scores are merely defined, but also adding or reducing points to specific items according to responses, the magnification ratio for compiled scores, and the like are defined.

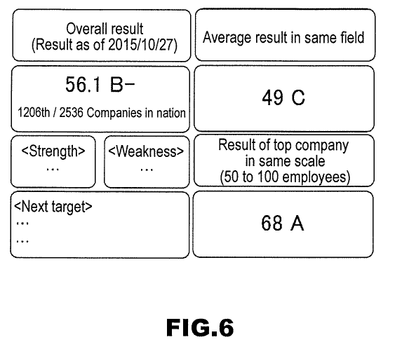

FIG. 6 is a display example in which a survey that is implemented in the engagement system 1 of this embodiment is organized and displayed from the viewpoint of work engagement to an organization or a supervisor. The inter-organization comparison displaying part 202 included in the engagement system 1 of this embodiment calculates a comprehensive score indicating members' engagement, based on the scores of the level at which organization members are satisfied with their organization, work, supervisors, and workplace, and expectation and satisfaction levels for the items related to the diagnosis regions, compiled for the organization in which the survey was implemented. Based on the result, a deviation value (hereinafter, a deviation value is referred to as an engagement score) or a rank order among the previously calculated scores of multiple organizations stored in the database 220 can be calculated and provided to the administrator terminal apparatuses 12. The scores related to engagement can be calculated, for example, by adding values weighted for the levels at which organization members are satisfied with their organization, work, supervisors, and workplace, and expectation and satisfaction levels for the items related to the diagnosis regions. The scores related to engagement may be calculated for each organization, for each organization department, or for each member attribute. The calculated engagement score or rank order may be displayed, for example, in comparison with those in organizations or departments in the same field, or in comparison with those in organizations or departments with a similar scale. With such display, if the work motivation for a work of an organization department or a member is lower, that is, the engagement is lower (the organization status is poorer) than that of other companies in the same field, it can be determined that it is necessary to rebuild the organization, whereas, if the engagement is higher (the organization status is better) than that of other companies in the same field, it can be determined that it is a time to expand the business.

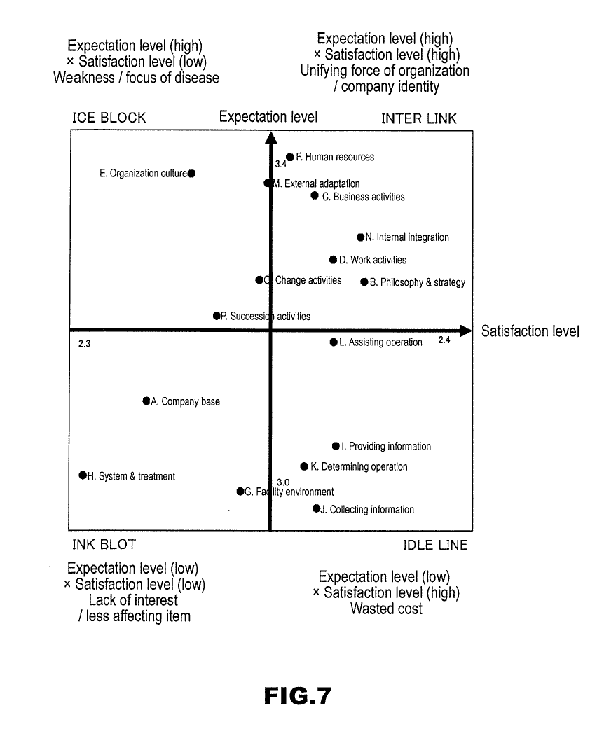

FIG. 7 is a display example in which a survey that is implemented in the engagement system 1 of this embodiment is organized such that items in diagnosis regions are plotted on two axes indicating expectation and satisfaction levels. As shown in FIG. 7, the intra-organization analysis displaying part 203 included in the engagement system 1 of this embodiment displays a result obtained by plotting the diagnosis items given as an example in FIG. 5 based on the compilation result of the responses to the survey questions, in a two-dimensional graph in which the scores compiled for expectation level and the scores compiled for satisfaction level are taken as axes. With such plotting, for example, it is easily seen that items with a high expectation level and a high satisfaction level from organization members are strengths of the organization and do not have to be improved for the moment, whereas items with a high expectation level but with a low satisfaction level from organization members are weaknesses of the organization and need some improvements. In the example shown in FIG. 7, for example, the items in diagnosis regions related to management (I. Providing information, J. Collecting information, K. Determining operation, L. Assisting operation) have generally low expectation levels, and thus it is seen that the organization members are working in a sufficiently independent manner. The item related to organization culture (E. Organization culture) has a high expectation level and a low satisfaction level, and thus it is seen that the organization culture has to be improved.

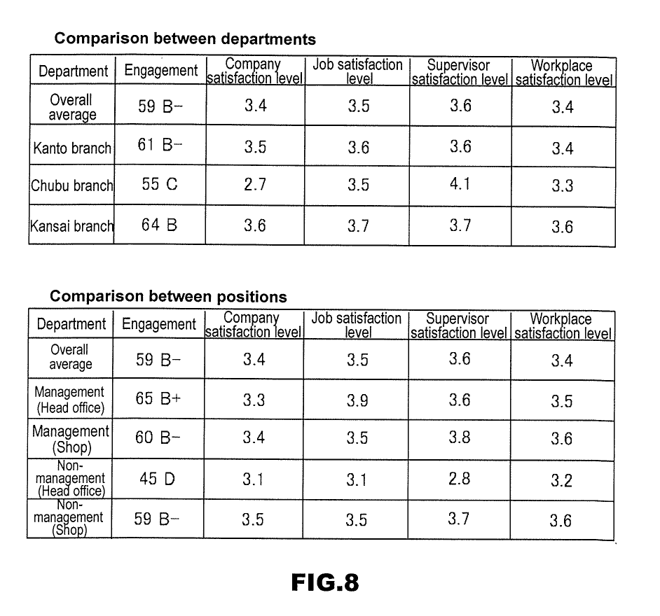

FIG. 8 is a display example in which a survey that is implemented in the engagement system 1 of this embodiment is organized from the viewpoint of department, position, sex, year joined the company, and the like. The intra-organization analysis displaying part 203 included in the engagement system 1 of this embodiment can calculate, for each attribute such as department or position in an organization in which a survey was implemented, a score obtained by compiling scores of the satisfaction level regarding supervisors, the item groups of diagnosis regions, and the items in diagnosis regions, a deviation value of the score, and the like, and provide them to the administrator terminal apparatuses 12. With such display, for example, it is seen from FIG. 8 that Chubu branch members have a low satisfaction level for the company and a high satisfaction level for supervisors, that is, the members have complaints about company management, and that head office members have significantly low engagement and satisfaction level for supervisors, that is, supervisors (work-site managers) and their staff are not getting along with each other at the work site. It is also possible that the intra-organization analysis displaying part 203 provides responses to survey questions related to a specific individual in response to a request from an administrator terminal apparatus 12 or a work-site manager terminal apparatus 14.

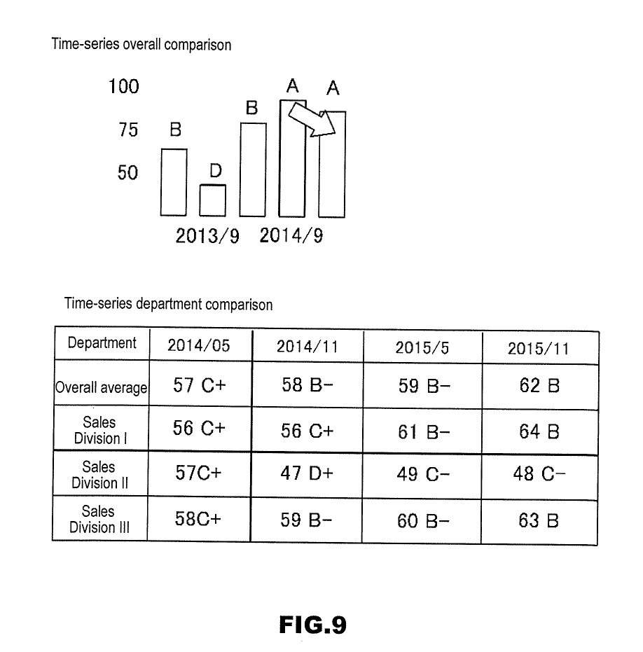

FIG. 9 is an example in which a result of a survey implemented according to the engagement system of this embodiment is displayed in comparison with previously accumulated analysis results of the same department in the same company. The time-series comparison displaying part 204 included in the engagement system 1 of the present invention can obtain, for each organization in which a survey was implemented or for each department of the organization, time-series changes of a score obtained by compiling scores of the work satisfaction level related to supervisors, the item groups of diagnosis regions, and the items in diagnosis regions, a deviation value of the score, and the like, and provide them to the administrator terminal apparatuses 12. With such display, for example, it is seen from the time-series overall comparison shown in FIG. 9 that it can be determined that a research has to be conducted because the engagement becomes lower compared with that half a year before although the overall standard is high. Furthermore, it is seen from the time-series department comparison shown in FIG. 9 that it can be determined that the organization of Sales Division II has to be organized again because it is unlikely to improve. The time-series comparison displaying part 204 may render time-series changes of items related to diagnosis regions in a two-dimensional graph in which the items related to diagnosis regions are plotted based on the expectation level and the satisfaction level shown in FIG. 7, in cooperation with the intra-organization analysis displaying part 203.

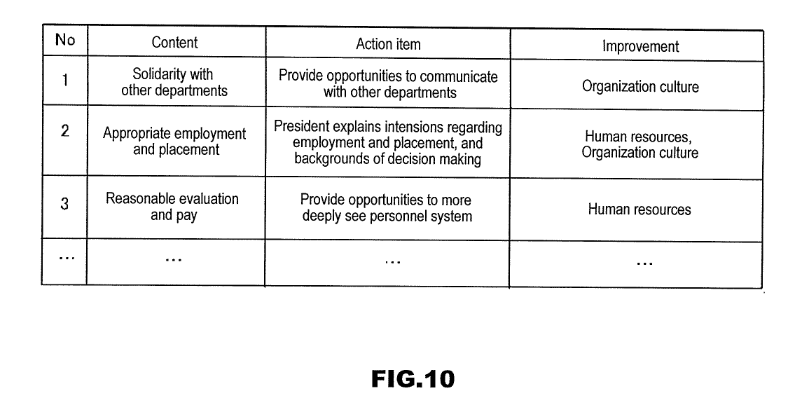

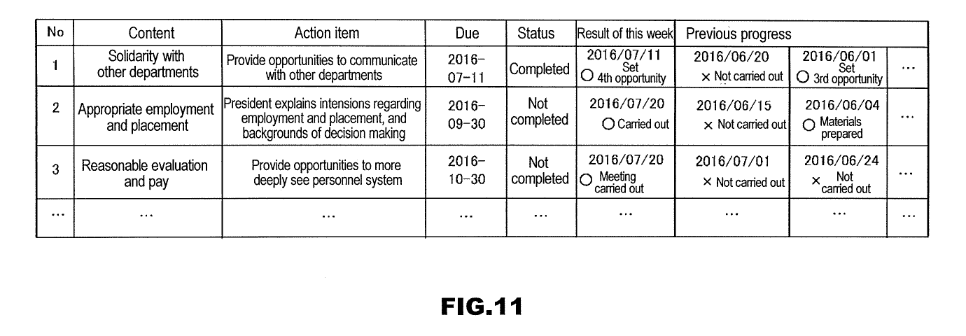

FIG. 10 is a table showing an example of action plans registered in the database 220 of the engagement system 1 of this embodiment. As shown in FIG. 10, action plans that are used in the engagement system 1 of this embodiment are defined as data including content of the action plans, action items of the action plans, items that will be improved by carrying out the action plans, and the like. The improvement item proposing part 205 included in the engagement system 1 of the present invention accepts designation of a range in which improvement is required (the entire organization, some departments, etc.), and an item that is required to be improved (engagement, item groups of diagnosis regions, and items in diagnosis regions), and the like, from administrators of the organization via the administrator terminal apparatuses 12 based on analysis results of implemented surveys, extracts at least one action plan from the database 220 based on the designated information, and proposes it to the administrator terminal apparatuses 12. In response to the administrators selecting an action plan from among the proposed action plans, the action plan setting part 206 sets the selected action plan in association with the range in which improvement is required, the implementation starting period set by the administrators, the implementation due date, and the like, as an action plan that is to be implemented, and stores the action plan in the database 220. The set action plan that is to be implemented is managed by the action plan progress managing part 207, and can be viewed from the administrator terminal apparatuses 12, and the work-site manager terminal apparatuses 14 in the range in which improvement is required. For the set action plan that is to be implemented, a progress status of the action plan can be registered to the database 220 from the work-site manager terminal apparatuses 14 in the range in which improvement is required, under the management by the action plan progress managing part 207, and, when the registered progress status is viewed from the administrator terminal apparatuses 12, the administrators can anytime see the progress status of the action plan that is to be implemented. If multiple action plans that are to be implemented are set, progress statuses of the multiple action plans that are to be implemented may be displayed in a list. FIG. 11 shows an example of progress status display of action plans that are to be implemented.

Even in the case in which there is no designation regarding a range in which improvement is required or an item that is required to be improved from administrators of organizations via the administrator terminal apparatuses 12, the improvement item proposing part 205 may extract items with poor scores, as improvement items, for organizations with poor scores or some departments with poor scores based on analysis results of implemented surveys, and automatically propose action plans for improving the improvement items.

Furthermore, the action plans registered in the database 220 may be statically generated in advance by a service company that provides the engagement system 1. In addition, for example, based on analysis results of surveys before and after a previously implemented action plan managed by the action plan progress managing part 207, an item related to a diagnosis region having a significant difference between before and after implementation of the action plan may be extracted as an item that seems to have been improved by the action plan, and this item may be added to improvement items of the action plan, or an item related to a diagnosis region having no significant difference between before and after implementation of the action plan although being set as an improvement item of the action plan may be eliminated from the improvement items of the action plan, that is, improvement items of action plans may be dynamically changed.

Furthermore, if an administrator operates the administrator terminal apparatus 12 or if a work-site manager operates the work-site manager terminal apparatus 14, a survey for human resources development can be implemented using a database, for a specific individual belonging to an organization or a department in an organization managed by the administrator or the work-site manager. The administrator or the work-site manager may instruct the individual to set an individual action plan that is to be implemented for the individual (setting of an action plan is assumed to use either a method through an individual terminal or a method through an administrator terminal) based on the survey result, and manage the progress status of the set individual action plan that is to be implemented.

Above, an embodiment of the present invention was described, but the invention is not limited to the foregoing embodiment. Various embodiments are possible through various modifications.

For example, in the foregoing embodiment, it was described that the engagement system 1 has a configuration in which multiple respondent terminal apparatuses 10, multiple administrator terminal apparatuses 12, multiple work-site manager terminal apparatuses 14, at least one survey server 100, and a management server 200 are connected to each other via a communication line such as the Internet, but it is also possible to omit each terminal or to omit the survey server 100 such that the engagement system 1 is constituted only by the management server 200. With this configuration, for example, sheets on which survey questions are printed are distributed, members of organizations are asked to fill in responses, the survey results are collected, and the survey results are input using an input part included in the management server 200. It is sufficient that the analysis results are such that administrators and work-site managers can view survey results, and set action plans and manage progress thereof, using a displaying part or an input part of the management server 200.

### LIST OF REFERENCE NUMERALS

1 Engagement system
10 Respondent terminal apparatus
12 Administrator terminal apparatus
14 Work-site manager terminal apparatus
100 Survey server
101 Survey implementation registering part
102 Survey question transmitting part
103 Survey question response receiving part
104 Survey response compiling part
105 Survey result transferring part
110 Interface server
120 Database
200 Management server
201 Survey result receiving part
202 Inter-organization comparison displaying part
203 Intra-organization analysis displaying part
204 Time-series comparison displaying part
205 Improvement item proposing part
206 Action plan setting part
207 Action plan progress managing part
210 Interface server
220 Database

1-4. (canceled)

5. An organization development assisting system for assisting reinforcement and improvement of an organization, comprising:
a first unit for acquiring scores regarding expectation levels and satisfaction levels, from responses of multiple members to multiple survey questions that are questions for which scores regarding expectation levels and scores regarding satisfaction levels are defined, and calculating a comprehensive score indicating members' motivation, using, as parameters, the multiple scores regarding the expectation levels and the satisfaction levels; and
a second unit for outputting the comprehensive score indicating the members' motivation.

6. The organization development assisting system according to claim 5,
wherein the multiple survey questions are questions for measuring expectation levels and satisfaction levels of items related to two or more diagnosis regions, and
the first unit calculates, for each of the two or more diagnosis regions, scores regarding expectation levels and satisfaction levels, from the responses of the multiple members, and calculates the comprehensive score indicating the members' motivation, using the scores regarding the expectation levels and the satisfaction levels for each of the diagnosis regions.

7. The organization development assisting system according to claim 5,
wherein the multiple survey questions further include questions for measuring satisfaction levels of organization members for one or more of their organization, work, supervisors, and workplace, and
the first unit further acquires scores regarding satisfaction levels of organization members for one or more of their organization, work, supervisors, and workplace, from the responses of the multiple members, and calculates the comprehensive score indicating the members' motivation, also using the scores regarding the satisfaction levels of the organization members for the one or more of their organization, work, supervisors, and workplace.

8. The organization development assisting system according to claim 6, further comprising:
an intra-organization analysis displaying unit for outputting a graph regarding expectation levels and satisfaction levels for items related to multiple diagnosis regions acquired by the first unit, in which the items related to the multiple diagnosis regions are plotted on a first axis indicating the expectation levels and a second axis indicating the satisfaction levels; and
an improvement item proposing unit for accepting designation of an item of a diagnosis region from an administrator of the organization after the intra-organization analysis displaying unit outputs the graph, acquiring information related to an action plan that is paired with the item indicated by the designation, from a database in which information related to action plans is stored in association with two or more items, and transmitting the information to an administrator terminal apparatus of the administrator.

9. The organization development assisting system according to claim 6, further comprising an improvement item proposing unit for extracting an item whose expectation level is higher and satisfaction level is lower than those of other items, among the items related to the multiple diagnosis regions, acquiring information related to an action plan that is paired with the item, from a database in which information related to action plans is stored in association with two or more items, and transmitting the information to an administrator terminal apparatus of the administrator.

10. The organization development assisting system according to claim 8, further comprising an action plan setting unit for accepting, from the administrator terminal apparatus, selection from the information related to the action plan transmitted by the improvement item proposing unit to the administrator terminal apparatus, and accumulating the accepted information related to the action plan, as an action plan that is to be implemented, in the database.

11. The organization development assisting system according to claim 8, wherein, in a case in which it is determined that there is no significant difference between a comprehensive score indicating members' motivation, which is an analysis result of a survey before implementation of the action plan, and a comprehensive score indicating members' motivation, which is an analysis result of a survey after implementation of the action plan, the information related to the action plan is deleted.

12. An organization development assisting method realized by an organization development assisting system including a first unit and a second unit, comprising:
a first step of the first unit acquiring scores regarding expectation levels and satisfaction levels, from responses of multiple members to multiple survey questions that are questions for which scores regarding expectation levels and scores regarding satisfaction levels are defined, and calculating a comprehensive score indicating members' motivation, using, as parameters, the multiple scores regarding the expectation levels and the satisfaction levels; and
a second step of the second unit outputting the comprehensive score indicating the members' motivation.

13. A program for causing a computer to function as:
a first unit for acquiring scores regarding expectation levels and satisfaction levels, from responses of multiple members to multiple survey questions that are questions for which scores regarding expectation levels and scores regarding satisfaction levels are defined, and calculating a comprehensive score indicating members' motivation, using, as parameters, the multiple scores regarding the expectation levels and the satisfaction levels; and
a second unit for outputting the comprehensive score indicating the members' motivation.

14. The organization development assisting system according to claim 6,
wherein the multiple survey questions further include questions for measuring satisfaction levels of organization members for one or more of their organization, work, supervisors, and workplace, and
the first unit further acquires scores regarding satisfaction levels of organization members for one or more of their organization, work, supervisors, and workplace, from the responses of the multiple members, and calculates the comprehensive score indicating the members' motivation, also using the scores regarding the satisfaction levels of the organization members for the one or more of their organization, work, supervisors, and workplace.

15. The organization development assisting system according to claim 7, further comprising:
an intra-organization analysis displaying unit for outputting a graph regarding expectation levels and satisfaction levels for items related to multiple diagnosis regions acquired by the first unit, in which the items related to the multiple diagnosis regions are plotted on a first axis indicating the expectation levels and a second axis indicating the satisfaction levels; and
an improvement item proposing unit for accepting designation of an item of a diagnosis region from an administrator of the organization after the intra-organization analysis displaying unit outputs the graph, acquiring information related to an action plan that is paired with the item indicated by the designation, from a database in which information related to action plans is stored in association with two or more items, and transmitting the information to an administrator terminal apparatus of the administrator.

16. The organization development assisting system according to claim 7, further comprising an improvement item proposing unit for extracting an item whose expectation level is higher and satisfaction level is lower than those of other items, among the items related to the multiple diagnosis regions, acquiring information related to an action plan that is paired with the item, from a database in which information related to action plans is stored in association with two or more items, and transmitting the information to an administrator terminal apparatus of the administrator.

17. The organization development assisting system according to claim 9, further comprising an action plan setting unit for accepting, from the administrator terminal apparatus, selection from the information related to the action plan transmitted by the improvement item proposing unit to the administrator terminal apparatus, and accumulating the accepted information related to the action plan, as an action plan that is to be implemented, in the database.
